(19) United States
(12) Patent Application Publication
(10) Pub. No.: US 2014/0040589 A1
(43) Pub. Date: Feb. 6, 2014

(54) NON-TRANSACTIONAL PAGE IN MEMORY

(71) Applicant: Takeshi Ogasawara, Tokyo (JP)

(72) Inventor: Takeshi Ogasawara, Tokyo (JP)

(73) Assignee: INTERNATIONAL BUSINESS MACHINES CORPORATION, Armonk, NY (US)

(21) Appl. No.: 13/568,434

(22) Filed: Aug. 7, 2012

Related U.S. Application Data
(63) Continuation of application No. 13/563,967, filed on Aug. 1, 2012.

(51) Int. Cl. G06F 12/02; G06F 12/10

(52) U.S. Cl. 711/170; 711/E12.002; 711/E12.059

(57) ABSTRACT

One or more embodiments are directed to allocating a page to put non-shared data to the page, setting a transactional property for the page, the transactional property indicating that data in the page does not need tracking by hardware transactional memory (HTM), in response to detecting an access to the page during a transaction, determining whether the transactional property for the page is set, and in response to determining that the transactional property for the page is set, handling data loaded from the page in a cache as non-transactional data.

### CROSS-REFERENCE TO RELATED APPLICATIONS AND PRIORITY CLAIM

This application is a continuation of U.S. Non-Provisional application Ser. No. 13/563,967, entitled “NON-TRANSACTIONAL PAGE IN MEMORY”, filed Aug. 1, 2012, which is incorporated herein by reference in its entirety.

### FIELD OF INVENTION

The present disclosure relates generally to memory utilization, and more specifically, to one or more non-transactional pages for hardware transactional memory (HTM).

### DESCRIPTION OF RELATED ART

Updates to a memory within a transaction performed by a thread might not be visible to other threads by using hardware transactional memory (HTM) until a transaction is committed. The amount of hardware resources to keep track of memory accesses within transactions is limited in HTM. As a result of limited resources, an overflow condition may occur if resource utilization exceeds resource capacity.

Prior solutions are slow with respect to transactions that cause HTM overflow. For example, acceleration by HTM cannot be used after HTM overflow. In terms of development, there are large costs involved in using special machine instructions that do not consume HTM resources for specific memory accesses. Such costs may be indicative of a modification of an instruction set architecture to include new instructions and the cost to develop or modify software tools to use the instructions. In terms of execution, software implementations typically are slow as a result of overhead incurred, such that it is not practical to utilize a software implementation.

### BRIEF SUMMARY

According to one or more embodiments of the present disclosure, an apparatus comprises at least one processor, and memory having instructions stored thereon that, when executed by the at least one processor, cause the apparatus to allocate a page to put non-shared data to the page, set a transactional property for the page, the transactional property indicating that data in the page does not need tracking by hardware transactional memory (HTM), in response to detecting an access to the page during a transaction, determine whether the transactional property for the page is set, and in response to determining that the transactional property for the page is set, handle data loaded from the page in a cache as non-transactional data.

According to one or more embodiments of the present disclosure, a non-transitory computer program product comprises a computer readable storage medium having computer readable program code stored thereon that, when executed by a computer, performs a method for using resources in a computer with hardware transactional memory (HTM), the method comprising allocating a page to put non-shared data to the page, setting a transactional property for the page, the transactional property indicating that data in the page does not need tracking by the HTM, in response to detecting an access to the page during a transaction, determining whether the transactional property for the page is set, and in response to determining that the transactional property for the page is set, handling data loaded from the page in a cache as non-transactional data.

According to one or more embodiments of the present disclosure, a system comprises at least one processor configured to execute an application that requests an allocation of a non-transactional page by setting a transactional property that indicates that the page does not need tracking by hardware transactional memory (HTM).

According to one or more embodiments of the present disclosure, a method for using resources in a computer with hardware transactional memory (HTM) is described, the method comprising allocating a page to put non-shared data to the page, setting a transactional property for the page, the transactional property indicating that data in the page does not need tracking by the HTM, in response to detecting an access to the page during a transaction, determining whether the transactional property for the page is set, and in response to determining that the transactional property for the page is set, handling data loaded from the page in a cache as non-transactional data.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features and advantages of the disclosure are apparent from the following detailed description taken in conjunction with the accompanying drawings in which:

FIG. 1 is a schematic block diagram illustrating an exemplary system architecture in accordance with one or more aspects of this disclosure.

FIG. 2 is a schematic block diagram illustrating an exemplary environment for transactional memory in accordance with one or more aspects of this disclosure.

FIG. 3 illustrates an exemplary state diagram in accordance with one or more aspects of this disclosure.

FIG. 4A illustrates a transactional memory in accordance with the prior art.

FIG. 4B illustrates an exemplary transactional memory in accordance with one or more aspects of this disclosure.

FIG. 5 is a flow diagram illustrating an exemplary method in accordance with one or more aspects of this disclosure.

### DETAILED DESCRIPTION

In accordance with various aspects of the disclosure, a minimization in terms of a number of memory accesses that utilize HTM resources may be obtained. In some embodiments, a parameter or flag may be used to indicate when HTM resources should be used to track a memory access, such as a memory access associated with a transaction.

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect.

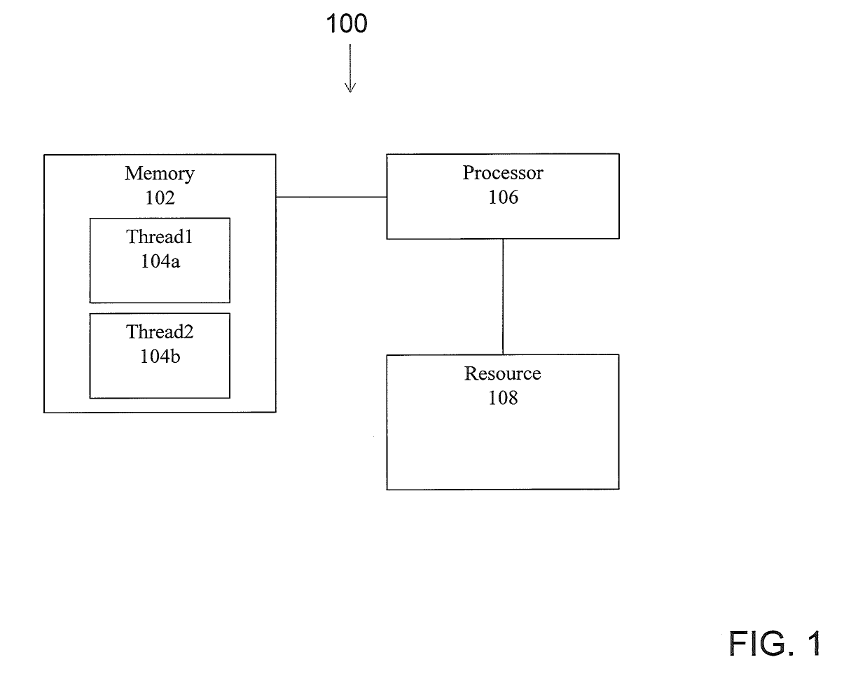

Referring to FIG. 1, an exemplary system architecture 100 is shown. The architecture 100 is shown as including a memory 102. The memory 102 may store executable instructions. The executable instructions may be stored or organized in any manner. As an example, at least a portion of the instructions are shown in FIG. 1 as being associated with a first thread 104a and a second thread 104b. The instructions stored in the memory 102 may be executed by one or more processors, such as a processor 106.

The threads 104a and 104b may be associated with a resource 108. For example, the resource 108 may include data, which may be organized as one or more blocks, objects, fields, or the like. The threads 104a and 104b may access the resource 108 concurrently (e.g., concurrently in terms of time or space), such that the resource 108 may be, or include, a shared resource. Embodiments of the disclosure may provide for a management of the resource 108. For example, the resource 108 may be managed in accordance with a memory management unit (MMU) as described below.

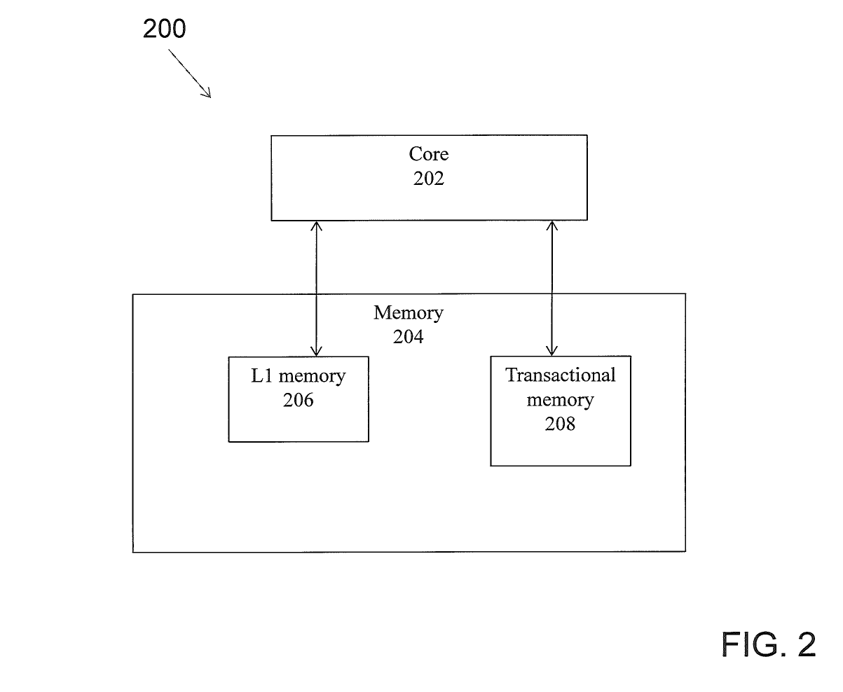

FIG. 2 illustrates a system environment 200 that may be used to manage memory accesses. The environment 200 may provide hardware support for a transactional memory. The environment 200 is shown as including a core 202 which may interact with a memory 204. In some embodiments, the core 202 and memory 204 may correspond to the memory 102 and the processor 106, respectively, of FIG. 1.

The core 202 may provide support for so-called “regular” memory accesses, which may occur with respect to a L1 memory 206 associated with the memory 204. The core 202 may provide support for “transactional” accesses, which may occur with respect to a transactional memory 208 associated with the memory 204. In some embodiments, the memory 206 and/or the memory 208 may include fields for a tag and data (e.g., old data and/or new data). In some embodiments, the memory 204, the memory 206, and/or the memory 208 may be associated with a cache. In some embodiments, the size or capacity of the memory 204, the memory 206, and/or the memory 208 may limit the number of memory accesses in HTM.

In some embodiments, in order to minimize the number of HTM accesses, one or more parameters or flags may be added to a memory management unit (MMU). For example, a “tx_disabled” bit may be added to one or more page table entries in the MMU. When memory (e.g., memory 102 of FIG. 1 or memory 204 of FIG. 2) is accessed during a transaction, HTM might not keep track of the access if the tx_disabled bit of the page table entry for the accessed memory is set, for example. Using the same example, HTM might keep track of the access if the tx_disabled bit of the page table entry for the accessed memory is cleared.

In some embodiments, a program may specify an attribute when mapping a memory page. When mapping a memory page using, e.g., a function or method such as mmap( ) the function or method may be called with an argument (e.g., “PROT_DISABLE_TX”) that establishes the value or state for the tx_disabled bit.

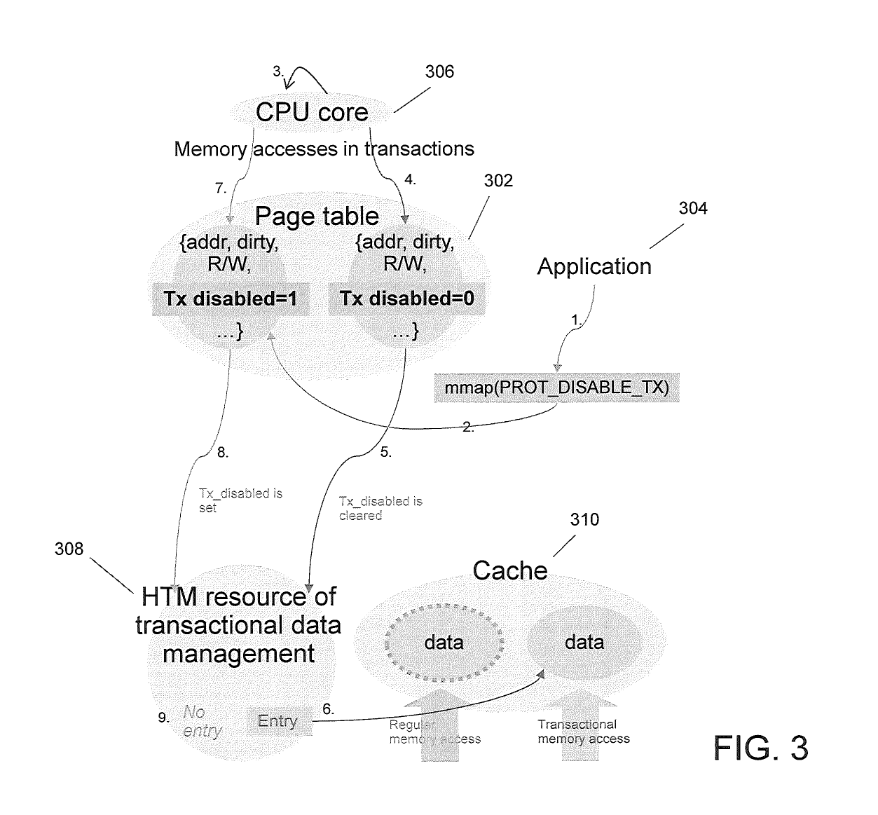

FIG. 3 illustrates an example of two memory accesses associated with a transaction, wherein HTM keeps track of a first of the accesses and wherein HTM does not keep track of a second of the accesses.

In a preliminary or initialization event (not shown in FIG. 3), the state of tx_disabled for each page table entry (PTE) in a page table 302 may be cleared. This initial clearing of the tx_disabled for each PTE may have the effect of causing a MMU or an HTM resource 308 to keep track of memory accesses by default while performing a transaction. As part of the preliminary event, the HTM resource 308 may be cleared. The clearing of the HTM resource 308 may serve to free transactional memory upon initialization or to maximize HTM resources that may be available for use.

In event 1, a program or an application 304 may call mmap( ) with the PROT_DISABLE_TX argument present or set to request an allocation of a non-transactional page. An example of a non-transactional page may be a stack of a thread that is not shared among speculative threads.

In event 2, the mmap may call a routine (e.g., a kernel service routine) to allocate a page with a PTE whose tx_disabled is set responsive to event 1.

In event 3, the application 304 (optionally as executed by a CPU core 306) may start a transaction. The transaction may be associated with the execution of one or more routines, threads, procedures, functions, etc.

In event 4, the application 304 may access memory a first time. The access may be based on a number of parameters, such as a dirty bit (e.g., an indication of whether a page has been modified), a read/write (R/W) status, etc. An address (addr) or page number associated with the first memory access may serve as an index to the page table 302 to facilitate a comparison or examination of the tx_disabled parameter for that memory access or page.

In event 5, the CPU core 306 may look up the PTE for the memory access of event 4 and determine that the tx_disabled parameter is cleared (e.g., equals zero).

In event 6, the HTM resource 308 may keep track of or log the memory access of event 4 as transactional data, optionally in response to an invocation or command provided by the CPU core 306 or the application 304. Data associated with the memory access of event 4 may be stored in, e.g., a cache 310.

In event 7, the application 304 may access memory a second time. An address or page number associated with the second memory access may serve as an index to the page table 302 to facilitate a comparison or examination of the tx_disabled parameter for that memory access or page.

In event 8, the CPU core 306 may look up the PTE for the memory access of event 7 and determine that the tx_disabled parameter is set (e.g., equals one).

In event 9, the HTM resource 308 might not keep track of or log the memory access of event 7, which may have the effect of logging the access as non-transactional data (e.g., as a “regular” memory access). Data associated with the memory access of event 7 may be stored in the cache 310.

Thus, as described above, the state of the tx_disabled parameter, as potentially set by the PROT_DISABLE_TX argument, determined whether a given memory access was a transactional memory access or a regular memory access. The state or value of the PROT_DISABLE_TX argument may be determined in a number of ways. For example, a tool may guide a programmer based on a run-time instance profile. In some embodiments, an Application Programming Interface (API) may be used to provide the state or value of the PROT_DISABLE_TX argument. In some embodiments, a Java Virtual Machine (JVM) may manage a heap, and based on that management, may know whether to set (or clear) the state or value of the PROT_DISABLE_TX argument. In some embodiments, the PROT_DISABLE_TX argument may be based on an identification of a region of memory.

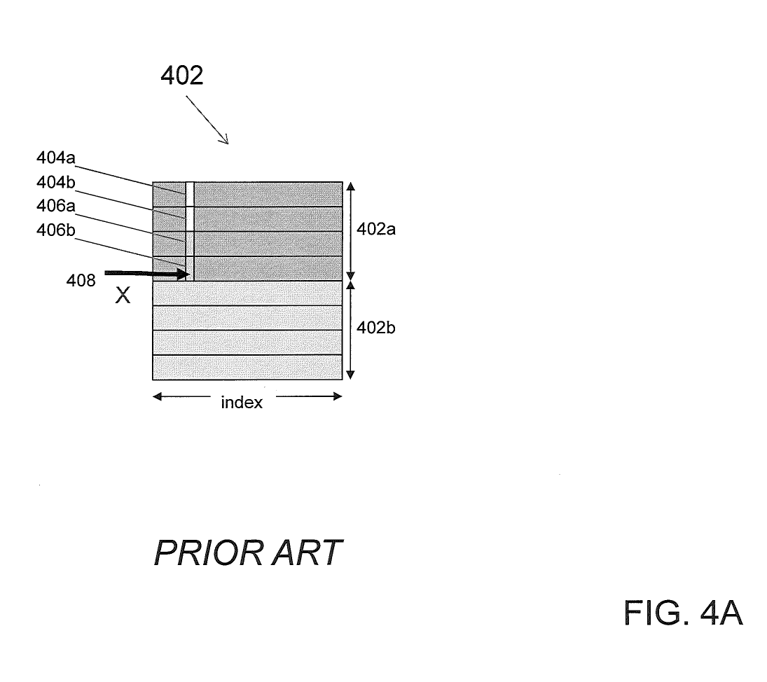

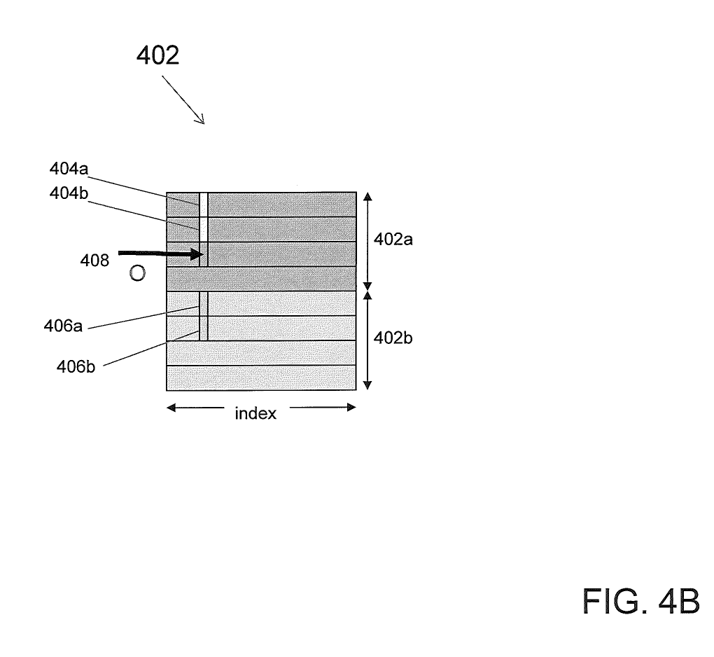

FIGS. 4A-4B may be used to illustrate a minimization of memory accesses that require HTM resources. As described below, HTM resources might not be shared or utilized by regular or non-transactional memory accesses.

FIG. 4A may be indicative of the state or operation of resources in accordance with the prior art. In FIG. 4A, a memory 402 (e.g., a L2 cache) may be partitioned as a transactional data page or area 402a and a non-transactional data page or area 402b. The sizes or densities of the transactional data area 402a and the non-transactional data area 402b may be equal or different.

A number of memory accesses (e.g., memory accesses denoted by 404a and 404b) may be indicative of transactional memory accesses, which may be shared among multiple threads and might be inconsistent if the threads update the shared memory without mutual exclusion control (e.g., lock). Similarly, a number of memory accesses (e.g., memory accesses denoted by 406a and 406b) may be indicative of regular or non-transactional memory accesses, which may be or include non-shared data and may be consistent if the threads update the memory without mutual exclusion control. The HTM might not need to keep track of such non-shared data, as the HTM might never abort transactions. Transactional memory accesses and non-transactional memory accesses may be performed during a transaction.

As reflected via FIG. 4A, the MMU in accordance with the prior art might not discriminate between transactional memory accesses (e.g., 404a and 404b) and non-transactional memory accesses (e.g., 406a and 406b), such that transactional memory accesses and non-transactional memory accesses may consume resources of the transactional data area 402a. An additional transaction (denoted by 408 in FIG. 4A) may abort when no additional slot is free or available in the transactional data area 402a, which may result in the execution of a throwback. The additional transaction 408 may be indicative of a transactional memory access.

FIG. 4B may be indicative of the state or operation of resources in accordance with one or more aspects of this disclosure. In contrast to FIG. 4A, in FIG. 4B the MMU may discriminate between transactional memory accesses (e.g., 404a and 404b) and non-transactional memory accesses (e.g., 406a and 406b), such that transactional memory accesses may consume resources of the transactional data area 402a and non-transactional memory accesses may consume resources of the non-transactional data area 402b. In FIG. 4B, a slot is available in the transactional data area 402a for the additional transaction 408.

Comparing FIGS. 4A and 4B, resources (e.g., HTM resources) may be conserved when discriminating between transactional memory accesses and non-transactional memory accesses. Such conservation may be achieved with a minimal number of changes. For example, operating systems and library routines may provide a new API to use the tx_disabled parameter. A managed runtime (e.g., JVM) may be configured to put non-shared data (e.g., java frames) to non-transactional pages. A new parameter or bit may be placed in each PTE. A modification may be made to the HTM so that accesses to non-transactional pages might not be tracked.

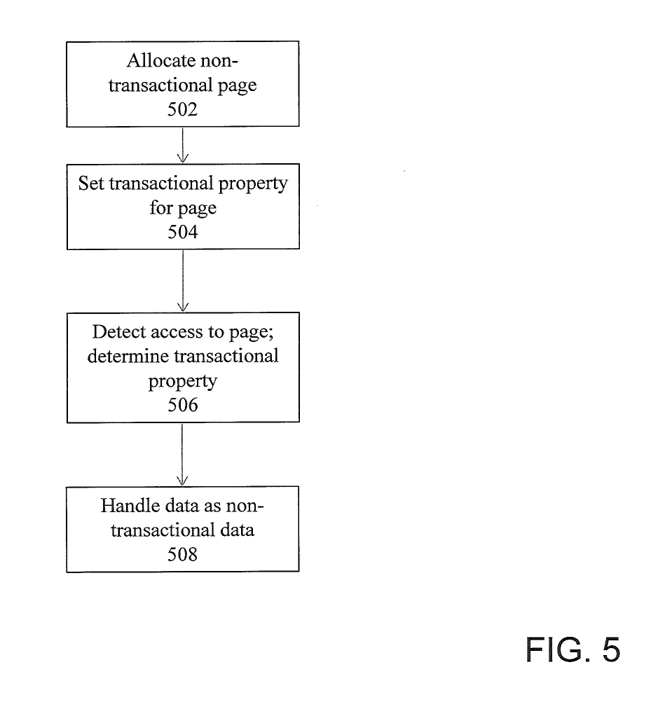

FIG. 5 illustrates a method that may provide for a utilization of resources in a device (e.g., a computer) with HTM.

In block 502, a non-transactional page may be allocated. The non-transactional page may be used to put or store non-shared data.

In block 504, a transactional property for the page of block 502 may be set. The transactional property may indicate that data in the page does not need tracking by HTM.

In block 506, in response to detecting an access to the page during a transaction, a determination may be made as to whether the transactional property for the page is set or not.

In block 508, in response to detecting that the transactional property for the page is set, data loaded from the page in a cache may be handled as non-transactional data.

It will be appreciated that the events of the state diagram of FIG. 3 and the method of FIG. 5 are illustrative in nature. In some embodiments, one or more of the operations or events (or a portion thereof) may be optional. In some embodiments, one or more additional operations not shown may be included. In some embodiments, the operations may execute in an order or sequence different from what is shown in FIG. 3 and/or FIG. 5. In some embodiments, operations of FIG. 3 and FIG. 5 may be combined to obtain a variation on the state diagram and method depicted in FIG. 3 and FIG. 5, respectively.

Aspects of the disclosure may be implemented independent of a specific instruction set (e.g., CPU instruction set architecture), operating system, or programming language. Aspects of the disclosure may be implemented in conjunction with non-transactional machine instructions. Aspects of the disclosure may be implemented in connection with thread-level speculation, which may be similar to HTM.

In some embodiments various functions or acts may take place at a given location and/or in connection with the operation of one or more apparatuses or systems. In some embodiments, a portion of a given function or act may be performed at a first device or location, and the remainder of the function or act may be performed at one or more additional devices or locations.

As will be appreciated by one skilled in the art, aspects of this disclosure may be embodied as a system, method or computer program product. Accordingly, aspects of the present disclosure make take the form of an entirely hardware embodiment, an entirely software embodiment (including firmware, resident software, micro-code, etc.) or an embodiments combining software and hardware aspects that may all generally be referred to herein as a “circuit,” “module” or “system.” Furthermore, aspects of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific example (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming language, including an object oriented programming language such as Java, Smalltalk, C++ or the like and conventional procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, an apparatus or system may comprise at least one processor, and memory storing instructions that, when executed by the at least one processor, cause the apparatus or system to perform one or more methodological acts as described herein. In some embodiments, the memory may store data, such as one or more data structures, metadata, etc.

Embodiments of the disclosure may be tied to particular machines. For example, in some embodiments one or more devices may allocate or manage resources, such as HTM resources. In some embodiments, the one or more devices may include a computing device, such as a personal computer, a laptop computer, a mobile device (e.g., a smartphones), a server, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There may be many variations to the diagram or the steps (or operations) described therein without departing from the spirit of the disclosure. For instance, the steps may be performed in a differing order or steps may be added, deleted or modified. All of these variations are considered a part of the disclosure.

It will be understood that those skilled in the art, both now and in the future, may make various improvements and enhancements which fall within the scope of the claims which follow.

What is claimed is:

1. A method for using resources in a computer with hardware transactional memory (HTM), the method comprising:
allocating a page to put non-shared data to the page;
setting a transactional property for the page, the transactional property indicating that data in the page does not need tracking by the HTM;
in response to detecting an access to the page during a transaction, determining whether the transactional property for the page is set; and
in response to determining that the transactional property for the page is set, handling data loaded from the page in a cache as non-transactional data.

2. The method of claim 1, further comprising:
storing a transactional property for each of a plurality of pages in a page table, the plurality of pages including the page.

3. The method of claim 2, further comprising:
determining that the transactional property for the page is set by examining the transactional property for the page in the page table.

4. The method of claim 1, further comprising:
receiving a request to allocate the page as a non-transactional page based on an argument included in the request.

5. The method of claim 1, further comprising:
detecting an access to a second page during the transaction.

6. The method of claim 5, further comprising:
in response to determining that a transactional property for the second page is cleared, handling data loaded from the second page in the cache as transactional data.

7. The method of claim 6, further comprising:
providing an entry to the HTM corresponding to the data loaded from the second page.

8. A method comprising:
allocating, by a computer, a page;
setting, by the computer, a transactional property for the page, the transactional property indicating whether data in the page needs tracking by hardware transactional memory (HTM);
in response to detecting an access to the page during a transaction, determining whether the transactional property indicates that data in the page needs tracking by HTM; and
in response to determining that the transactional property indicates that data in the page does not need tracking by HTM, handling data loaded from the page in a memory as non-transactional data.

9. The method of claim 8, further comprising:
detecting, by the computer, an access to a second page during the transaction; and
in response to determining that a transactional property for the second page indicates that data in the second page needs tracking by HTM, handling data loaded from the second page in the memory as transactional data.

10. The method of claim 8, wherein the memory comprises a cache.

11. A non-transitory computer program product comprising a computer readable storage medium having computer readable program code stored thereon that, when executed by a computer, performs a method for using resources in a computer with hardware transactional memory (HTM), the method comprising:
allocating a page to put non-shared data to the page,
setting a transactional property for the page, the transactional property indicating that data in the page does not need tracking by the HTM,
in response to detecting an access to the page during a transaction, determining whether the transactional property for the page is set, and
in response to determining that the transactional property for the page is set, handling data loaded from the page in a cache as non-transactional data.

12. The computer program product of claim 11, wherein the method further comprises:
storing a transactional property for each of a plurality of pages in a page table, the plurality of pages including the page.

13. The computer program product of claim 12, wherein the method further comprises:
determining that the transactional property for the page is set by examining the transactional property for the page in the page table.

14. The computer program product of claim 11, wherein the method further comprises:
receiving a request to allocate the page as a non-transactional page based on an argument included in the request.

15. The computer program product of claim 11, wherein the method further comprises:
detecting an access to a second page during the transaction.

16. The computer program product of claim 15, wherein the method further comprises:
in response to determining that a transactional property for the second page is cleared, handling data loaded from the second page in the cache as transactional data.

17. The computer program product of claim 16, wherein the method further comprises:
providing an entry to the HTM corresponding to the data loaded from the second page.
